(19) United States
(12) Patent Application Publication
(10) Pub. No.: US 2012/0072690 A1
(43) Pub. Date: Mar. 22, 2012

(54) MEMORY DEVICE AND METHOD OF TRANSFERRING DATA

(75) Inventor: Taichi EJIRI, Nagoya-shi (JP)

(73) Assignee: Buffalo Inc., Nagoya-shi (JP)

(21) Appl. No.: 13/235,438

(22) Filed: Sep. 18, 2011

(30) Foreign Application Priority Data
Sep. 22, 2010 (JP) 2010-212119

(51) Int. Cl. G06F 12/14

(52) U.S. Cl. 711/162; 711/163; 711/E12.103; 711/E12.098

(57) ABSTRACT

A USB-SATA conversion circuit board of a memory device includes a data traffic counter that retains a data traffic transferred in accordance with a reading command within a certain time period. Subsequently, the data transfer is prohibited when it is determined that the data is transferred from the memory device to the host device at a speed faster than a data transfer speed requisite at the time of playing of a motion image based on a value retained by the data traffic counter.

### CROSS-REFERENCE TO RELATED APPLICATION

This application claims the benefit of Japanese Patent Application No. 2010-212119 filed on Sep. 22, 2010, the entire disclosure of which is incorporated herein by reference.

### BACKGROUND OF THE INVENTION

1. Field of the Invention

The present invention relates to a memory device which is connected to a host device and a method of transferring data.

2. Description of the Related Art

Various memory devices which are capable of recording contents data, such as video and music products are widely used. Moreover, memory devices, such as an external hard disk drive and a USB memory, which are connected to a host device through a general-purpose interface such as a USB (Universal Serial Bus) have the memory capacities increased and the prices thereof decreased.

Recently, a technique is known which distributes a further large amount of motion image data without using a network such as the Internet by distributing a memory device which stores motion image data in advance. When such a distribution method of motion image data is directly applied as it is, there is a possibility that the motion image data may be illegally copied from the memory device to another memory device which is built in a host device. Therefore, in order to prevent such an unauthorized data copying, there has conventionally been applied a technique of encrypting motion image data stored in a memory device and decrypting the data when the data is played.

When the above-described encryption technique that prevents data copying is applied, however, a decryption process by the host device is necessary, so that playing of data is disabled for a general-purpose motion image playing software on the host device or for a general-purpose media player device, resulting in a poor user-friendliness.

The present invention has been made to overcome the problem of the above-described conventional technique, and it is an object of the present invention to provide a memory device that is capable of preventing the unauthorized copying of data and improving the user-friendliness. It is another object of the present invention to provide a method of transferring data that is capable of preventing such unauthorized copying of data and improving the user-friendliness.

### SUMMARY OF THE INVENTION

The present invention provides a memory device which is connectable to a host device, and which includes a data traffic monitoring unit that monitors a data traffic per a predetermined time period from the memory device to the host device, and a data transfer unit that prohibits data transfer from the memory device to the host device when the data traffic per the predetermined time period monitored by the data traffic monitoring unit is equal to or greater than a predetermined amount.

When motion image data stored in the memory device is played by the host device, a data traffic per a unit time, i.e., a data transfer speed depends mainly on the bit rate of the motion image. Conversely, when data stored in the memory device is copied in another memory medium which is built in the host device, the data transfer speed depends on a memory medium such as a hard disk of the memory device, a process speed of the host device, and a hardware such as an interface which connects the memory device and the host device together.

For example, motion image data stored in a Blu-ray Disk (registered trademark), more specifically, a disk in a BD-ROM standard has a bit rate that is 54 Mbps (Mega bit per seconds) at maximum which is the maximum reading speed of the BD-ROM. A data transfer speed between the host device and the memory device necessary at the time of playing motion image data stored in the Blu-ray Disk (registered trademark) is close to the bit rate of the motion image. Moreover, when a USB 2.0 is used as an interface that connects the memory device and the host device together, the maximum data transfer speed is 480 Mbps. A data transfer speed at the time of copying data stored in the memory device to another memory media which is built in the host device is close to the maximum data transfer speed of the interface. The data transfer speed necessary at the time of playing motion image differs from the data transfer speed at the time of copying the data, and the data transfer speed necessary at the time of playing motion image is generally slower.

According to the present invention, the memory device may further include a reading region determination unit that determines whether or not data is read from a predetermined memory region of the memory device in accordance with a data transfer from the memory device to the host device, in which a data transfer from the memory device to the host device may be prohibited only when the reading region determination unit determines that the data is read from the predetermined memory region.

Moreover, according to the memory device of the present invention, the memory device may store motion image data that has a data transfer rate at a time of playing set to be a predetermined value, and a data transfer rate at the time of copying of data from the memory device to the host device may be set to be a predetermined value, and the data transfer unit may prohibit data transfer from the memory device to the host device when a data traffic per the predetermined time period monitored by the data traffic monitoring unit is larger than the predetermined value at a time of playing of the motion image data in a case in which the predetermined value at the time of copying of data is larger than the predetermined value at the time of playing of the motion image data.

Furthermore, according to the present invention, when the data transfer rate at the time of copying of data is set to be two kinds: a predetermined value larger than the data transfer rate at the time of playing of the motion image data, and a predetermined value smaller than the data transfer rate at the time of playing of the motion image data, the data transfer unit may prohibit data transfer from the memory device to the host device at the smaller predetermined value.

Still further, the present invention provides a method of transferring data from a memory device to a host device connected to the memory device which includes a process of monitoring a data traffic per a predetermined time period from the memory device to the host device, and a process of prohibiting the data transfer from the memory device to the host device when the data traffic per the predetermined time period monitored by the former process is equal to or more than a predetermined value.

According to the present invention, it becomes possible to prevent an unauthorized data copying, to play motion image data regardless of the host device to which the memory device of the present invention is connected, and to improve the user-friendliness.

Note that the present invention can be realized as, other than the above-described memory device, a program applied for the memory device, a memory medium that stores the program, and a data transfer method from the memory device, etc.

### BRIEF DESCRIPTION OF DRAWINGS

FIG. 1 is a diagram showing a hardware configuration of a memory device according to an embodiment of the present invention; and

FIG. 2 is a flowchart of an operation according to the embodiment of the present invention.

### DETAILED DESCRIPTION OF THE PREFERRED EMBODIMENT

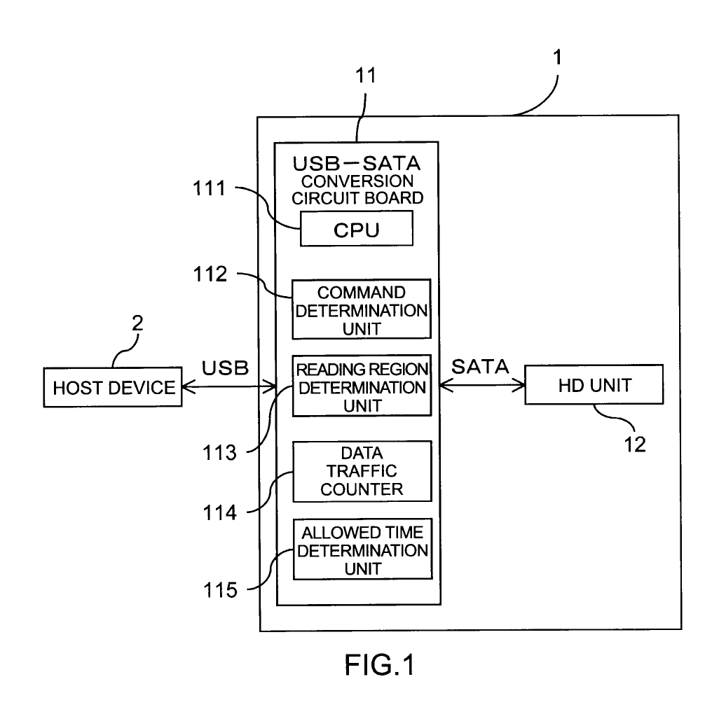

FIG. 1 shows a hardware configuration of a memory device according to an embodiment of the present invention. A memory device 1 is connected to a host device 2 through a USB (Universal Serial Bus).

The memory device 1 includes a USB-SATA conversion circuit board 11 and a hard disk unit 12. The USB-SATA conversion circuit board 11 is connected to the host device 2 through the USB and is also connected to the hard disk unit 12 by SATA (Serial Advanced Technology Attachment).

The USB-SATA conversion circuit board 11 includes a CPU 111. The number of the hard disk units 12 of the memory device 1 may be one or a plural number, and each hard disk unit 12 may have a plurality of logical memory regions.

The USB-SATA conversion circuit board 11 includes a command determination unit 112 that determines the kind of a command that is input from the host device 2 through the USB. Moreover, the USB-SATA conversion circuit board 11 includes a reading region determination unit 113 that determines whether or not a memory region to be read is a region which stores motion image data when the command determination unit 112 determines that the command input from the host device 2 is a reading command.

The USB-SATA conversion circuit board 11 also includes a data traffic counter 114 that retains data volume which is transferred in accordance with the reading command within a certain time period. Moreover, the USB-SATA conversion circuit board 11 further includes an allowed time determination unit 115 that determines whether or not a time period at which data is transferred at a speed faster than an allowed data transfer speed is within the predetermined allowed time set beforehand based on the value of the data traffic counter 114. The allowed data transfer speed in this embodiment is faster than the data transfer speed that is requisite at the time of playing a motion image, and is slower than the data transfer speed that is requisite at the time of copying data. At least one of the command determination unit 112, the reading region determination unit 113, the data traffic counter 114, and the allowed time determination unit 115 may be realized as a function of the CPU 111 that runs an unillustrated software, or may also be realized by an exclusive hardware circuit.

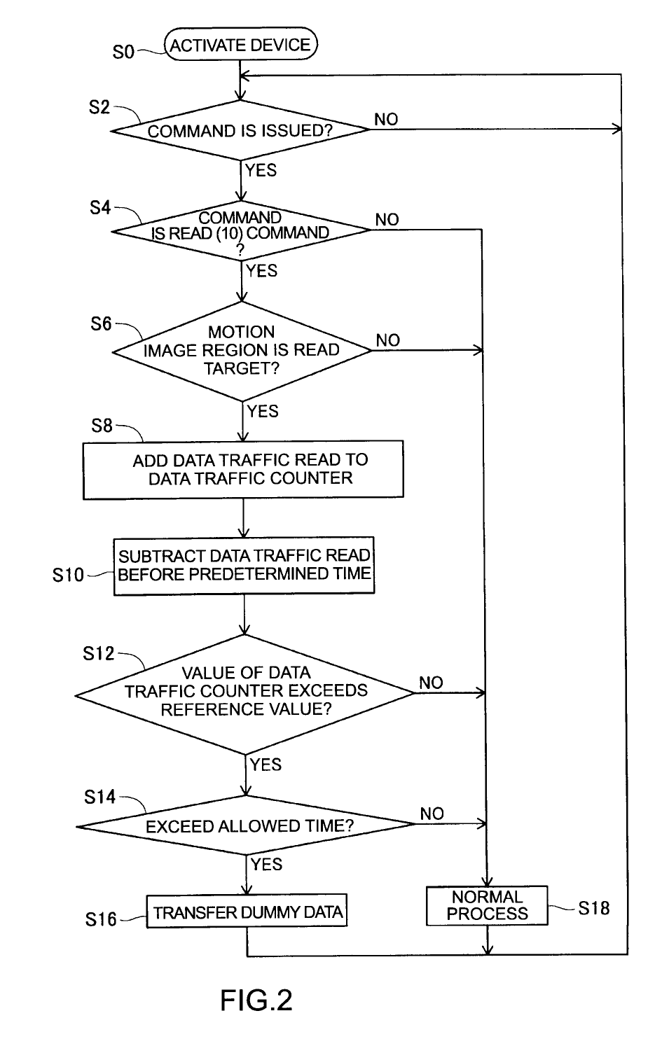

FIG. 2 is a flowchart of an operation of the memory device 1 according to the present embodiment. The host device 2 and the memory device 1 are activated in step 0. Next, the memory device 1 is in a command waiting mode (step S2) until a command is issued from the host device 2 to the USB-SATA conversion circuit board 11 of the memory device 1 through the USB.

Once the command is issued from the host device 2 to the USB-SATA conversion circuit board 11 (step S2: YES), the command determination unit 112 of the USB-SATA conversion circuit board 11 determines whether or not the kind of the issued command is a reading command (step S4). An example reading command that is issued from the host device 2 to the USB-SATA conversion circuit board 11 is a READ (10) command which is one of SCSI (Small Computer System Interface) commands issued through a USB bus.

In the step S4, when the command determination unit 112 determines that the command issued to the USB-SATA conversion circuit board 11 is not the READ (10) command (step S4: NO), the USB-SATA conversion circuit board 11 executes a normal process based on the issued command (step S18), and shifts the mode to the command waiting mode in the step S2.

In the step S4, when the command determination unit 112 determines that the command issued to the USB-SATA conversion circuit board 11 is the READ (10) command (step S4: YES), the reading region determination unit 113 of the USB-SATA conversion circuit board 11 determines data reading target based on the READ (10) command (step S6). When the memory device 1 includes a plurality of hard disk units 12 or a plurality of logical memory regions, it is presumed that one of or a plurality of logical memory regions or hard disk units are a motion image region for storing motion image data. As a determination result of the step S6, when the data reading target is not the motion image region (step S6: NO), the USB-SATA conversion circuit board 11 normally reads data (step S18) and shifts the mode to the command waiting mode in the step S2.

As a determination result of the step S6, when the data reading target is the motion image region based on the READ (10) command (step S6: YES), a transfer rate monitoring control from step S8 to step S16 is executed.

In the step S8, the data traffic by the READ (10) command is added to the data traffic counter 114 of the USB-SATA conversion circuit board 11. Next, data traffic which is read based on the READ (10) command is subtracted from the data traffic counter 114 before a predetermined time (step S10). Next, the value of the data traffic counter 114 is compared with a predetermined reference value (step S12). A value obtained by dividing the predetermined reference value in the step S12 by the predetermined time in the step S8 is the data transfer speed allowed in the present embodiment. Therefore, the predetermined time in the step S8 and the predetermined reference value in the step S12 are set based on the allowed data transfer speed.

In the step S12, when the value of the data traffic counter 114 does not exceed the reference value (step S12: NO), i.e., when data is read at a speed equal to or slower than the allowed data transfer speed, data is normally read (step S18), and the memory device 1 shifts the mode to the command waiting mode in the step S2. When the value of the data traffic counter 114 exceeds the reference value (step S12: YES), i.e., when data is read at a speed faster than the allowed data transfer speed, the allowed time determination unit 115 of the USB-SATA conversion circuit board 11 determines whether or not a time period at which the data is transferred at the speed faster than the allowed data transfer speed is within the allowed time (step S14).

In the step S14, when the time period at which the data is transferred at the speed faster than the allowed data transfer speed is within the allowed time (step S14: NO), the memory device 1 normally reads data (step S18), and shifts the mode to the command waiting mode (step S2). In the step S14, when the time period at which data is transferred at the speed faster than a prohibited data transfer speed exceeds the allowed time (step S14: YES), dummy data is transferred to the host device (S16). Thereafter, the memory device 1 shifts the mode to the command waiting mode (step S2).

The reason why the allowed time is set in the step S14 is that, for example, a data transfer speed when playing of a motion image is started may become temporarily faster than the allowed data transfer speed. Moreover, the dummy data transferred in the step S16 is empty data or invalid data, etc.

Next, a working and effect of the present embodiment will be described below. The data traffic counter 114 of the memory device 1 according to the present embodiment monitors the data traffic per a predetermined time period from the memory device 1 to the host device 2. Next, when it is determined that the data traffic per the predetermined time period does not exceed the bit rate of the motion image data and the motion image is played, the USB-SATA conversion circuit board 11 permits data transfer. When it is determined that the data traffic per the predetermined time period exceeds the bit rate of the motion image data and data in the memory device 1 is copied, the USB-SATA conversion circuit board 11 prohibits data transfer. Through the operation described above, the present invention accomplishes working and effect of preventing an unauthorized data copying, enabling playing of motion image data regardless of the host device 2, and improving the user-friendliness.

When the memory device 1 has a plurality of hard disk units 12 or a plurality of logical memory regions, it is presumed that one of or a plurality of logical memory regions are motion image regions for storing motion image data. It is also presumed that a user can write data in the memory region which is not the motion image region. Moreover, the USB-SATA conversion circuit board 11 of the memory device 1 includes the reading region determination unit 113 that determines whether or not the memory region where data is read is the motion image region. Next, when the data reading target is not the motion image region, the data traffic counter 114 does not monitor the data traffic from the memory device 1 to the host device 2. Through the above-described operation, when the user writes data to the memory region other than the motion image region, a process such as copying can be performed freely on that data.

Moreover, in the step S14 of the operation flow shown in FIG. 2, data transfer at a speed faster than the allowed data transfer speed is permitted within the allowed time. In this way, even if the data traffic temporary increases after playing of a motion image is started, it becomes possible to permit the playing of the motion image and to prevent an unauthorized data copying.

Note that the present invention is not limited to the above-described embodiment, and it is needless to say that the present invention can be changed and modified in various forms without departing from the scope and spirit of the present invention. For example, a modification can be made which encrypts motion image data stored in the hard disk unit 12 and which adds a process of causing the USB-SATA conversion circuit board 11 to decrypt such data at the time of data transfer to the host device 2. By causing the USB-SATA conversion circuit board 11 to execute a decryption process, even if a user disassembles the memory device 1 and takes out the hard disk unit 12, it is possible to prevent an unauthorized data copying since the motion image data stored in the hard disk unit 12 is encrypted.

Moreover, when the motion image region which stores motion image data is a read-only region, it is possible to prevent the user from falsely delete the motion image data.

Furthermore, in a case of a standard having a downward compatibility between generations, such as a USB, a data transfer speed when data is copied in accordance with a downward standard and a data transfer speed of reading and playing of motion image data are both slower than the data transfer speed in accordance with an upward standard. Hence, it is difficult to determine data transfer when the data is copied using the downward standard and data transfer of reading and playing of the motion image data from respective transfer speeds. Therefore, an operation at a slow transfer speed of the downward standard is prohibited in the standard having the downward compatibility. For example, when the memory device 1 is a compatible device with a USB 3.0, data reading in USB 2.0 and USB 1.1 connections is prohibited. Accordingly, it becomes possible to determine whether the operation is reading and playing of motion image data and copying thereof under the standard having the downward compatibility.

Note that the USB in the above-explained embodiment is an illustrative interface used to connect the host device 2 and the memory device 1 together. For example, it may be other interfaces such as an IEEE (the Institute of Electrical and Electronics Engineers) 1394. Moreover, the SATA that is used to connect the USB-SATA conversion circuit board 11 and the hard disk unit 12 together is an illustrative interface used for a connection with the hard disk unit 12. For example, it may be other interfaces such as a Serial Attached SCSI. Furthermore, the hard disk unit 12 is an illustrative memory device used to store digital information, and needless to say, it may be other memory media such as an SSD (Solid State Drive)

Note that the USB-SATA conversion circuit board 11 in the above-explained embodiment is an illustrative circuit that converts an interface between the interface of the host device 2 and the interface of the hard disk unit 12, and is also an illustrative data transfer unit. Moreover, the data traffic counter 114 is an illustrative data traffic monitoring unit.

What is claimed is:

1. A memory device which is connectable to a host device, the memory device comprising:
a data traffic monitoring unit that monitors a data traffic per a predetermined time period from the memory device to the host device; and
a data transfer unit that prohibits data transfer from the memory device to the host device when the data traffic per the predetermined time period monitored by the data traffic monitoring unit is equal to or greater than a predetermined amount.

2. The memory device according to claim 1, further comprising a reading region determination unit that determines whether or not data is read from a predetermined memory region of the memory device in accordance with a data transfer from the memory device to the host device,
wherein a data transfer from the memory device to the host device is prohibited only when the reading region determination unit determines that the data is read from the predetermined memory region.

3. The memory device according to claim 1, wherein
the memory device stores motion image data that has a data transfer rate at a time of playing set to be a predetermined value, and a data transfer rate at the time of copying of data from the memory device to the host device is set to be a predetermined value, and
the data transfer unit prohibits data transfer from the memory device to the host device when a data traffic per the predetermined time period monitored by the data traffic monitoring unit is larger than the predetermined value at a time of playing of the motion image data in a case in which the predetermined value at the time of copying of data is larger than the predetermined value at the time of playing of the motion image data.

4. The memory device according to claim 3, wherein when the data transfer rate at the time of copying of data is set to be two kinds: a predetermined value larger than the data transfer rate at the time of playing of the motion image data; and a predetermined value smaller than the data transfer rate at the time of playing of the motion image data, the data transfer unit prohibits data transfer from the memory device to the host device at the smaller predetermined value.

5. A method of transferring data from a memory device to a host device connected to the memory device, the method comprising:
a process of monitoring a data traffic per a predetermined time period from the memory device to the host device; and
a process of prohibiting the data transfer from the memory device to the host device when the data traffic per the predetermined time period monitored by the former process is equal to or more than a predetermined value.
